(19) United States
(12) Patent Application Publication
(10) Pub. No.: US 2010/0257469 A1
(43) Pub. Date: Oct. 7, 2010

(54) METHOD OF COMPOSING DISPLAY IN MOBILE TERMINAL

(75) Inventors: June Seok Kim, Seoul (KR); In Chang Jung, Seoul (KR); Hyo Jin Bae, Seoul (KR); Ji Hye Myung, Gyeonggi-do (KR); Min Sun Lee, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/754,964

(22) Filed: Apr. 6, 2010

(30) Foreign Application Priority Data
Apr. 7, 2009 (KR) 10-2009-0030053

(51) Int. Cl. G06F 3/048

(52) U.S. Cl. 715/763; 715/835

(57) ABSTRACT

A method of composing a graphic user interface (GUI) of a mobile terminal permits easier and more convenient composition of a GUI related to a theme. The method preferably includes: identifying attribute information of at least one GUI element of a plurality of GUI elements composing a display screen of the mobile terminal. Attribute information is extracted of the remaining GUI elements other than the least one GUI element in which the attribute information is selected from among the plurality of GUI elements based on the attribute information of the selected at least one GUI element; displaying the plurality of GUI elements reflecting the selected attribute information and the extracted attribute information; and composing, if a setting completion instruction is input, a GUI with the displayed plurality of GUI elements.

### CLAIM OF PRIORITY

This application claims the benefit of priority from Korean Patent Application entitled “METHOD OF COMPOSING DISPLAY IN MOBILE TERMINAL” No. 2009-0030053 filed Apr. 7, 2009, the contents of which are hereby incorporated by reference in its entirety.

### BACKGROUND OF THE INVENTION

1. Field of the Invention

The present invention relates to a method of composing a graphic user interface (GUI) in a mobile terminal. More particularly, the present invention relates to a method of permitting a user to construct their own visual settings in a mobile terminal.

2. Description of the Related Art

Mobile terminals are now widely used and are quickly becoming the primary device for communication not only for voice, but for data transmission, entertainment, commerce, etc. Such a mobile terminal typically provides various data transmission services and various additional services as well as an intrinsic voice communication service and is thus used as a multimedia communication appliance.

Conventionally, a menu screen of a mobile terminal is provided to a user in a fixed image form. In other words, while the user can directly set a background image of a standby screen, the menu screen itself cannot be directly set. However, a function for enabling the user to directly compose a menu screen was desired by a considerable number of users, and a ‘theme setting’ function has been developed in response to such consumer demand. The theme setting function is a function for enabling the user to compose a background screen or a menu screen directly, and the user can directly compose a theme by selecting a shape, color, and character color of a background screen.

However, because the theme setting function provided in the mobile terminal requests processes of several steps, the theme setting function is inconvenient for a user to implement and requires much time to understand the process and select all the items. Particularly, a process of individually setting all GUI elements composing a theme is very inconvenient to a user. Accordingly, there is a need for a method of enabling a user to set a theme more easily and conveniently than known heretofore.

### SUMMARY OF THE INVENTION

The present invention provides a method of composing more easily and conveniently a graphic user interface (GUI) related to a theme.

In accordance with an exemplary aspect of the present invention, a method of composing a guide user interface (GUI) of a mobile terminal, preferably includes: (a) identifying attribute information of at least one GUI element of a plurality of GUI elements composing a display screen of the mobile terminal; (b) extracting attribute information of the remaining GUI elements other than said at least one GUI element identified in (a) from among the plurality of GUI elements composing a display screen based on the attribute information of said at least one GUI element identified in (a); (c) displaying the plurality of GUI elements reflecting the identified attribute information and the extracted attribute information; and (d) composing, upon a setting completion key being activated, a GUI with the displayed plurality of GUI elements.

In accordance with an exemplary aspect of the present invention, a method of composing a GUI of a mobile terminal preferably includes: selecting attribute information of at least one GUI element of a plurality of GUI elements composing a display screen of the mobile terminal; extracting attribute information of the remaining GUI elements other than at least one GUI element in which the attribute information is selected from among the plurality of GUI elements based on the attribute information of the selected at least one GUI element; displaying the plurality of GUI elements reflecting the selected attribute information and the extracted attribute information; and composing, if a setting completion instruction is input, a GUI with the displayed plurality of GUI elements.

In accordance with another exemplary aspect of the present invention, a mobile terminal of composing a GUI includes: a storage unit for connecting and storing attribute information of the remaining GUI elements to attribute information of at least one GUI element of a plurality of GUI elements composing a display screen; a display unit for displaying a menu screen for composing a GUI and the composed GUI; and a controller for controlling, if an instruction for selecting attribute information of at least one GUI element of a plurality of GUI elements composing the display screen is input, to compose a GUI by extracting the selected attribute information and attribute information of the remaining GUI elements connected thereto from the storage unit and the display unit to display the composed GUI.

### BRIEF DESCRIPTION OF THE DRAWINGS

The above features and advantages of the present invention will become more apparent from the following detailed description in conjunction with the accompanying drawings, in which:

FIG. 1 is a block diagram illustrating a configuration of a mobile terminal according to an exemplary embodiment of the present invention;

FIG. 2 is a diagram illustrating a connection form of GUI elements composing a theme according to another exemplary embodiment of the present invention;

FIG. 3 is a flowchart illustrating a method of setting a theme according to a first exemplary embodiment of the present invention;

FIGS. 4a to 4e illustrate examples of a display screen in a process of performing the method of FIG. 3;

FIG. 5 is a flowchart illustrating a method of setting a theme according to a second exemplary embodiment of the present invention;

FIGS. 6a to 6e illustrate examples of a display screen in a process of performing the method of FIG. 5;

FIG. 7 is a flowchart illustrating a method of setting a theme according to a third exemplary embodiment of the present invention;

FIG. 8 is a flowchart illustrating a method of setting a theme according to a fourth exemplary embodiment of the present invention;

FIGS. 9a to 9e illustrate examples of a display screen in a process of setting a theme according to the third and fourth exemplary embodiments of the present invention;

FIG. 10 is a flowchart illustrating a method of setting a theme according to a fifth exemplary embodiment of the present invention; and

FIGS. 11a to 11c illustrate examples of a display screen in a process of performing the method of FIG. 10.

### DETAILED DESCRIPTION

Hereinafter, exemplary embodiments of the present invention are described in detail with reference to the accompanying drawings. The same reference numbers are used throughout the drawings to refer to the same or like parts. The views in the drawings are not intended to be to scale or correctly proportioned. Detailed descriptions of well-known functions and structures incorporated herein may be omitted to avoid obscuring appreciation of the subject matter of the present invention by a person of ordinary skill in the art.

In the following description, a ‘theme’ is a skin kind (i.e. a type of template) related to a display screen of a mobile terminal by which a user can directly change a style. In exemplary embodiments of the present invention, a ‘theme’ corresponds to a skin kind related to a menu screen of a mobile terminal and is generally formed with a plurality of GUI elements.

A ‘GUI element’ is at least one graphic element composing a ‘theme’. For example, a background screen, character, and icon composing a ‘theme’ correspond to a ‘GUI element’ in the present exemplary embodiment.

‘Attribute information’ is a specific data value of each GUI element composing a theme. For example, ‘form and color’ of a background screen and ‘form and color’ of a character correspond to ‘attribute information’ in the present exemplary embodiment.

In exemplary embodiments of the present invention, a display screen of mobile terminal is exemplified, however the presently claimed invention is not limited thereto and can be applied to a large size display appliance such as a television, computer, notebook computer, laptop computer, tablet computer, netbook, etc. The mobile terminal according to the present exemplary embodiment may comprise an information and communication device or a multimedia device such as a mobile communication terminal, portable multimedia player (PMP), personal digital assistant (PDA), smart phone, MP3 player, and applications thereof.

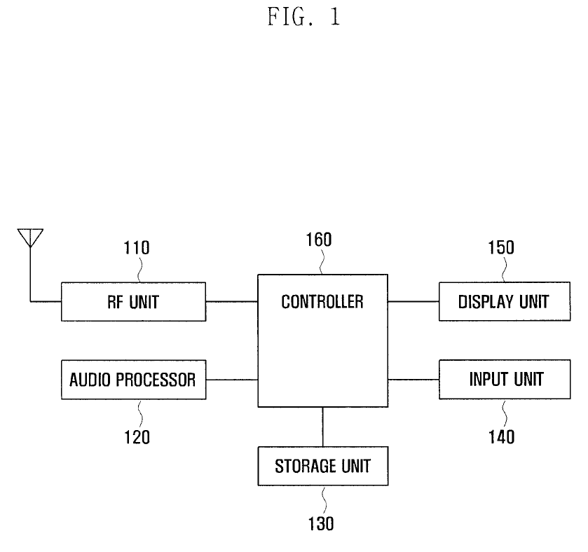

FIG. 1 is a block diagram illustrating a configuration of a mobile terminal according to an exemplary embodiment of the present invention.

Referring now to FIG. 1, a mobile terminal according to the present exemplary embodiment preferably includes a radio frequency (RF) unit 110, audio processor 120, storage unit 130, input unit 140, display unit 150, and a controller 160.

The RF unit 110 performs a transmitting and receiving function of corresponding data for performing wireless communication of the mobile terminal. The RF unit 110 preferably includes an RF transmitter for up-converting a frequency of a signal to be transmitted and amplifying the signal, and an RF receiver for low-noise amplifying a received signal and down-converting a frequency of the signal. The RF unit 110 also receives data through a wireless channel to output the data to the controller 160 and transmits data output from the controller 160 through a wireless channel.

The audio processor 120 is formed with a codec, and the codec includes a data codec for processing packet data and an audio codec for processing an audio signal, such as sound. The audio processor 120 converts a digital audio signal to an analog audio signal through the audio codec and reproduces the analog audio signal through a speaker SPK, and converts an analog audio signal input from a microphone MIC to a digital audio signal through the audio codec. In the present exemplary embodiment, the audio processor 120 converts a sound signal received from the RF unit 110 to an analog audio signal and reproduces the analog audio signal through the speaker SPK. Further, the audio processor 120 converts an analog audio signal received from the microphone MIC to a digital audio signal and outputs the digital audio signal to the controller 160.

The storage unit 130 performs a function of storing a program and data necessary for operating a mobile terminal and is preferably divided into a program area and a data area. In the present exemplary embodiment, the storage unit 130 stores image data such as a picture image, pattern image, and effect image. Further, the storage unit 130 stores attribute information of at least one GUI element composing a theme. In the present exemplary embodiment, when storing attribute information of GUI elements, the storage unit 130 connects and stores attribute information of at least one GUI element of a plurality of GUI elements composing a theme and attribute information of the remaining GUI elements.

The input unit 140 receives a user's key manipulation signal for controlling the mobile terminal by outputting the key manipulation signal to the controller 160. The input unit 140 can be formed with a keypad including numeral keys and direction keys, and can be formed with a touch pad in a touch screen-based mobile terminal. Further, in a mobile terminal having an image sensor and an acceleration sensor, the sensors are included in the input unit 140. In the present exemplary embodiment, a user can enter a theme setting menu through the input unit 140 and input an instruction for selecting or changing attribute information of a plurality of GUI elements composing a theme.

The display unit 150 preferably can be formed with a liquid crystal display (LCD) but any other thin-film screen technology can be used with the presently claimed invention. The display unit 150 visually provides a menu of information to the user including, for example, input data, function setting information, and other various information to a user. For example, the display unit 150 performs a function of outputting a booting screen, standby screen, display screen, communication screen, caller identification screen, and many other application execution screens of a mobile terminal. In the present exemplary embodiment, the display unit 150 performs a function of displaying a theme setting menu screen and a theme that is set by a user.

It is also within the spirit and scope of the claimed invention that the display unit and input unit could comprise a single touchscreen for some or for all functions of the mobile terminal.

With continued reference to FIG. 1, the controller 160 performs a function of controlling general operations of a mobile terminal.

In the first exemplary embodiment of the present invention, the controller 160 determines that a pattern image theme setting menu is selected through receipt of signals from the input unit 140, and controls the display unit 150 to display a plurality of pattern images stored in the storage unit 130 in accordance with the received input signals. When one of the displayed plurality of pattern images is selected, the controller 160 extracts attribute information of the remaining GUI elements connected to the selected pattern image from the storage unit 130. For example, the controller 160 extracts a color of a background screen, a color and brightness of a predetermined area, and a color and brightness of a character connected to the selected pattern image. In the present exemplary embodiment, the attribute information of a plurality of GUI elements is user-selectable. For example, the background screen color as well as a pattern image of GUI elements composing a theme are selectable. In this case, the controller 160 extracts a combination of the selected pattern image and a background screen color and a color and brightness of a predetermined area, and a color and brightness of a character connected thereto. The controller 160 controls the display unit 150 to display the extracted attribute information.

In a second exemplary embodiment of the present invention, the controller 160 determines that a preset theme setting menu is selected through receiving signals from the input unit 140 and controls the display unit 150 to display a plurality of theme images stored in the storage unit 130.

In a third exemplary embodiment of the present invention, the controller 160 determines that a picture image theme setting menu is selected through the receipt of signals from the input unit 140 and controls the display unit 150 to display a plurality of picture images stored in the storage unit 130. In response to one of the displayed plurality of picture images being selected, the controller 160 controls a display of a menu screen for changing the brightness of the picture image. The controller 160 determines a picture image brightness change instruction input through the input unit 140 and controls the display unit 150 to change and display a color and brightness of GUI elements according to the change instruction. In a fourth exemplary embodiment of the present invention, in a state where a plurality of picture images stored in the storage unit 130 are displayed in the display unit 150, when the controller 160 determines that a picture image has been selected, the controller 160 determines an area in which GUI elements are to be positioned on the selected picture image, and analyzes a color and brightness of the determined area. The controller 160 extracts a color and brightness of GUI elements connected to correspond to the analyzed color and brightness from the storage unit 130 and controls the display unit 150 to display GUI elements according to the extracted color and brightness.

In a fifth exemplary embodiment of the present invention, the controller 160 determines that an effect image theme setting menu has been selected and controls the display unit 150 to display a plurality of effect images stored in the storage unit 130. The controller 160 determines that one of displayed plurality of effect images has been selected and controls the display unit 150 to extract attribute information of GUI elements connected to the selected effect image. In the present exemplary embodiment, attribute information of a GUI element other than an effect image of GUI elements composing a theme can be additionally selected by a user. In this case, the controller 160 extracts attribute information of the selected GUI elements and attribute information of GUI elements connected thereto from the storage unit 130. The controller 160 sets a theme according to the extracted attribute information and controls the display unit 150 to display the set theme.

In the present exemplary embodiment, the controller 160 determines whether or not a setting completion key or an edition key is input using the input unit 140. When the controller 160 determines that a setting completion key is input through the input unit 140, the controller 160 stores a set theme in the storage unit 130, and when the controller 160 determines that an edition key is input, the controller 160 controls the display unit 150 to display a menu for changing attribute information of GUI elements. The controller 160 changes the GUI elements according to a user's attribute information change instruction and controls the display unit 150 to display the GUI elements. In the present exemplary embodiment, the controller 160 extracts attribute information of the changed GUI element and attribute information of the remaining GUI elements connected thereto from the storage unit 130.

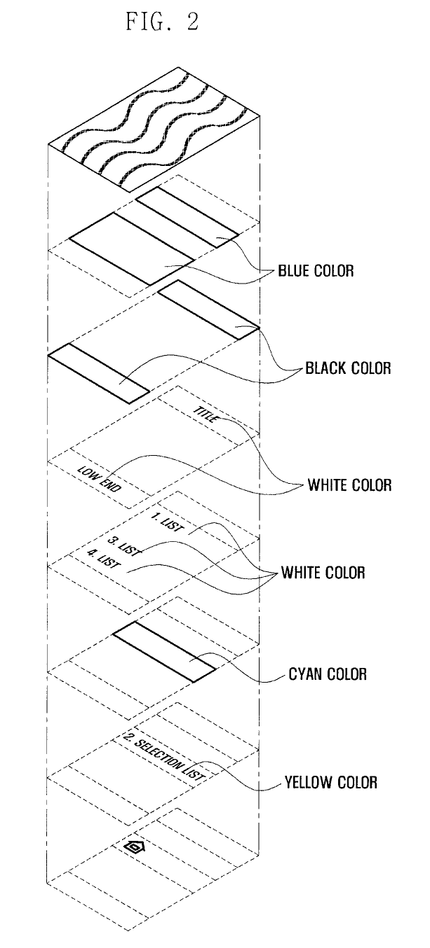

FIG. 2 is a diagram illustrating a connection form of GUI elements composing a theme according to another exemplary embodiment of the present invention.

When describing the first exemplary embodiment of exemplary embodiments of the present invention as an example, GUI elements such as a background image, character, predetermined area divided on a display screen, and an icon are included in the ‘theme’, and the theme is composed by setting attribute information (a kind of a pattern image, color of a background screen, color of a main character, color of title/low end, color of title/low end character, color of a selection area (focus area), character color of a selection area, and kind of an icon), etc., of GUI elements.

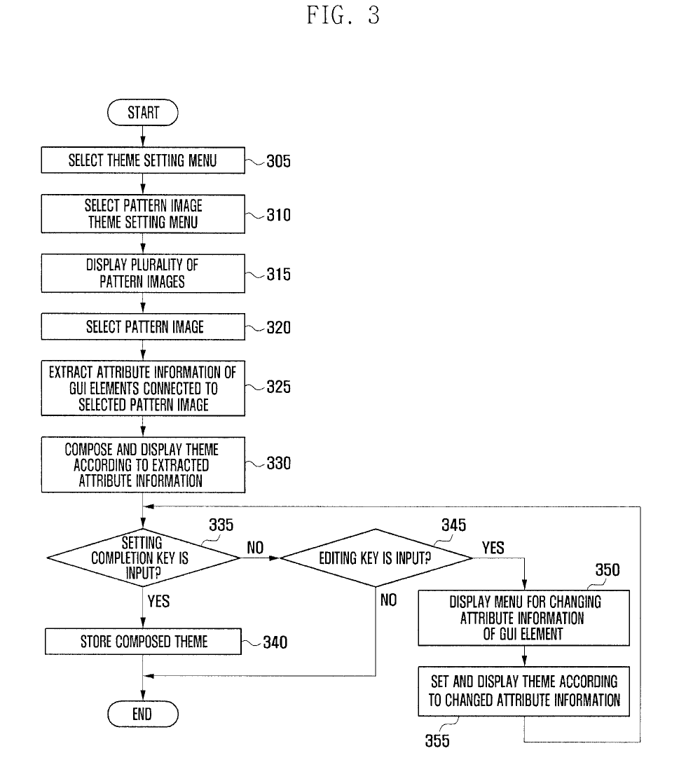

Referring now to FIG. 2, a pattern image of a ‘wave pattern’ and a background color of a blue color, title/low end color of a black color, title/low end character color of a white color, main character color of a white color, selection area color of a cyan color, selection area character color of a yellow color, and icon kind of a house shape are connected and stored in the storage unit 130. Attribute information of GUI elements is connected and stored in consideration of an aesthetic point of view and character readability. In exemplary embodiments of the present invention, other attribute information of the remaining GUI elements can be connected to and stored in a pattern image of a ‘wave pattern’, and attribute information of the remaining GUI elements of each of all pattern images can be connected and stored. Further, an attribute information combination of a plurality of GUI elements and attribute information of the remaining GUI elements can be connected and stored. For example, a title/low end color of a black color, title/low end character color of a white color, main character color of a white color, selection area color of a cyan color, a selection area character color of a yellow color, and an icon kind of a house shape can be connected to a combination of a pattern image of a ‘wave pattern’ and a background screen color of a ‘blue color’ and they can be stored. FIG. 3 is a flowchart illustrating a method of setting a theme according to a first exemplary embodiment of the present invention.

At step (305), the controller 160 determines that a theme setting menu is selected by the user using the input unit 140. The theme setting menu can be included in a main menu of a mobile terminal and/or can also be included in a user setting menu. When the controller 160 determines a selection instruction of a theme setting menu, the controller 160 causes display unit 150 to display lower-level menus of the theme setting menu. In the present exemplary embodiment, a lower-level menu of the theme setting menu includes a pattern image theme setting menu, preset theme setting menu, picture image theme setting menu, and effect image theme setting menu. In the first exemplary embodiment of the present invention, a pattern image theme setting menu is selected.

At step (310), the controller 160 determines that a pattern image theme setting menu is selected by the user using the input unit 140.

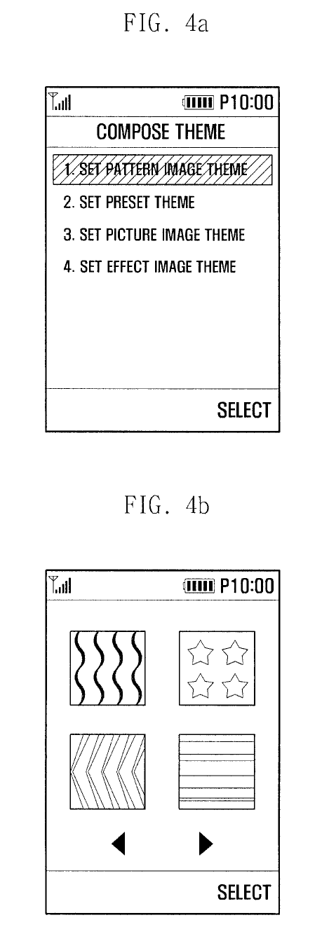

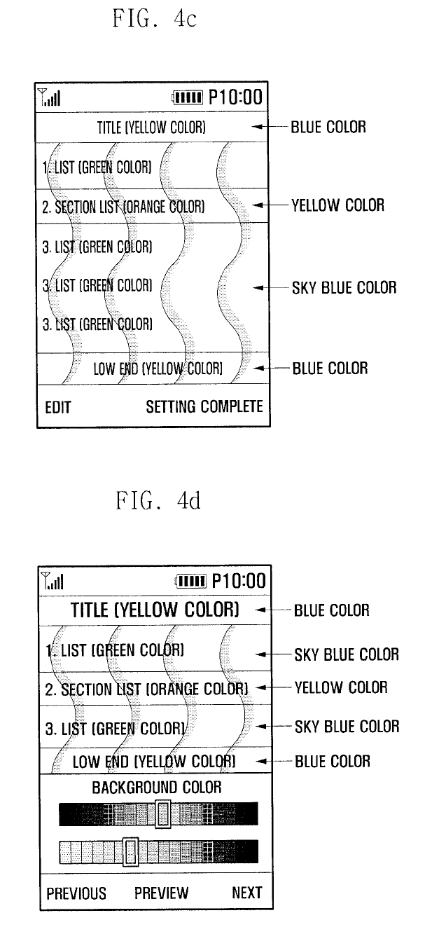

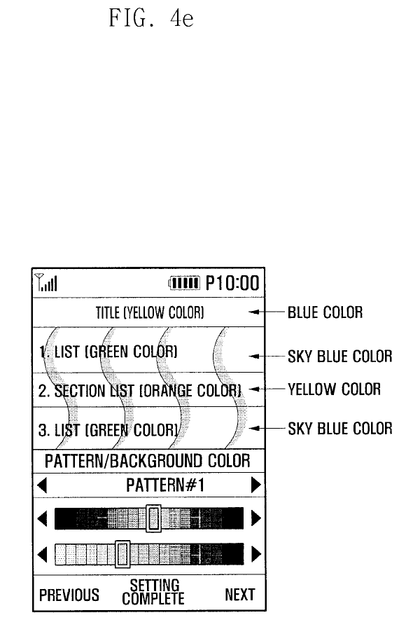

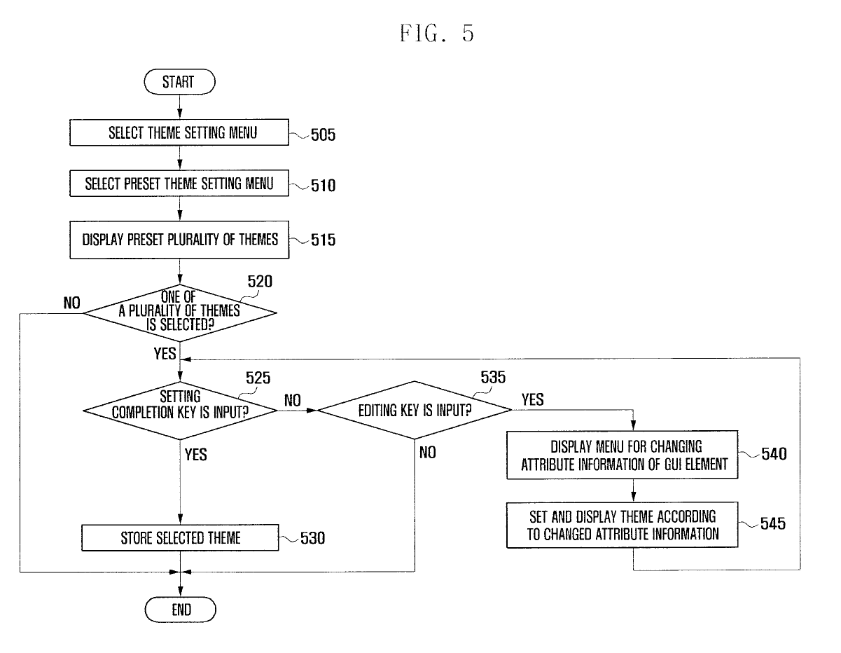

FIG. 4a illustrates an exemplary display screen for selecting a pattern image theme setting menu of theme setting lower-level menus.

At step (315), if a pattern image theme setting menu is selected, the controller 160 extracts a plurality of pattern images stored in the storage unit 130 and controls the display unit 150 to display the extracted pattern images. In the present invention, a ‘pattern image’ comprises an image having a predetermined shape stored at a production time point of a mobile terminal. The pattern image may not include a color as a pattern form image of black and white and may be a picture form image including a color. In the present exemplary embodiment, the pattern image may be received from the outside through the RF unit 110 and stored in the storage unit 130.

FIG. 4b illustrates a display screen for displaying pattern images stored in the mobile terminal.

At step (320), the controller 160 determines that one of a plurality of pattern images displayed in the display unit 150 is selected by the user using the input unit 140 (320).

FIG. 4b illustrates a display screen for selecting a pattern image of a ‘wave pattern’.

At step (325), the controller 160 extracts attribute information of GUI elements stored to connect to the selected pattern image from the storage unit 130.

In the first exemplary embodiment of the present invention, attribute information of GUI elements composing a ‘theme’ corresponds to a pattern image kind, background screen color, main character color, title/low end area color, title/low end character color, selection area (focus area) color, and selection area character color, and the controller 160 extracts attribute information of the remaining GUI elements connected to a specific pattern image kind from the storage unit 130. For example, when a pattern image of a wave pattern and a background color of a sky blue color, main character color of a green color, title/low end area color of a blue color, title/low end character color of a yellow color, selection area color of a yellow color, and selection area character color of an orange color are connected and stored, the controller 160 extracts attribute information of a GUI element stored to connect to a pattern image of the wave pattern from the storage unit 130.

In the present exemplary embodiment, an attribute information combination of a plurality of GUI elements and attribute information of the remaining GUI elements among GUI elements composing a theme are connected and stored.

In this particular case, the controller 160 extracts attribute information of a plurality of GUI elements selected by the user and attribute information of the remaining GUI elements connected thereto from the storage unit 130. For example, when a combination of a pattern image of a ‘wave pattern’ and a background screen color of a ‘sky blue’ color; and a main character color of a green color, title/low end area color of a blue color, title/low end character color of a yellow color, selection area color of a yellow color, and selection area character color of an orange color are stored to connect, if the user selects a pattern image of a ‘wave pattern’ and a background screen color of a ‘sky blue’ color, the controller 160 extracts a main character color of a green color, title/low end area color of a blue color, title/low end character color of a yellow color, selection area color of a yellow color, and selection area character color of an orange color from the storage unit 130.

In the present exemplary embodiment, the quantity of GUI elements in which the user can select attribute information can be changed. For example, when the entire quantity of GUI elements composing a theme is “8”, the user can set the quantity of GUI element for selecting attribute information to “1” or a plural number. In the present exemplary embodiment, a menu for setting the quantity of GUI elements for selecting attribute information can be included in an auxiliary menu of a theme setting menu, and the user can select the quantity of GUI elements for selecting attribute information within a range of from 1 to the entire quantity of GUI elements composing a theme. A menu for setting the quantity of GUI elements for selecting attribute information may be formed with a menu that can individually select a GUI element to select attribute information of GUI elements composing a theme.

At step (330), the controller 160 composes a theme based on the extracted attribute information and controls the display unit 150 to display the composed theme.

FIG. 4c illustrates a display screen for displaying a theme composed by the controller 160.

At step (335), the controller 160 determines whether a setting completion key is input by the user using the input unit 140. When the user requests storage of the theme displayed at step 330, a setting completion key is input that signals same to the controller 160.

At step (340), if a setting completion key is input, the controller 160 stores a composed theme in the storage unit 130. When storing a theme, the controller 160 controls the display unit 150 to display a message for requesting an input of a theme title. The controller 160 forms themes that are set by the user as a list and stores the themes in the storage unit 130. The themes stored in the storage unit 130 can be loaded by a user's instruction and can be transmitted to another party through wireless communication or short range communication using protocols such as Bluetooth, Zigbee, and IrDA, just to name a few possibilities. If a setting completion key is not input at step 335, then at step (345), the controller 160 determines whether or not an editing key is input by the user using the input unit 140. When the user wants to edit attribute information of the GUI element instead of storing the theme displayed at step 330, an editing key is input.

At step (350), if an editing key is input, the controller 160 controls the display unit 150 to display a menu for changing attribute information of a GUI element. A menu for changing attribute information of a GUI element can be formed in one step or a plurality of steps. For example, the controller 160 controls the display unit 150 to display step-by-step menus for changing a background screen color, main character color, title/low end area color, title/low end character color, selection area (focus) color, and selection area character color, and the user can gradually change from the background screen color to the selection area character color. In the present exemplary embodiment, a menu of each step can be formed with a menu for changing a hue, brightness, and opacity. In the present exemplary embodiment, a menu for changing a hue, brightness, and opacity can be formed in a control bar form.

FIG. 4d illustrates a menu for changing attribute information of a GUI element according to an exemplary embodiment of the present invention.

The background color can be changed via a color adjustment bar (preferably positioned at a lower part of the display screen).

At step (355), the controller 160 controls the display unit 150 to display a theme according to the changed attribute information. For example, when the user inputs an instruction for changing a background screen color from a sky blue color to a yellow color through the input unit 140, the controller 160 controls the display unit 150 to change and display the background color from a sky blue color to a yellow color. In the present exemplary embodiment, the controller 160 extracts the pattern image selected at step 320 and an attribute information combination of a GUI element changed by the user at step 345 and attribute information of the remaining GUI elements connected thereto from the storage unit 130, composes a theme, and controls the display unit 150 to display the composed theme. For example, when a combination of a pattern image of a ‘wave pattern’ and a background screen color of a ‘yellow’ color and a main character color of a red color, title/low end area color of an orange color, title/low end character color of a yellow color, selection area color of a yellow color, and selection area character color of a orange color are stored to connect, the controller 160 extracts the connection information from the storage unit 130, composes a theme, and controls the display unit 150 to display the composed theme. The user can change attribute information of the remaining GUI element step-by-step, and the controller 160 extracts a combination of attribute information of the changed GUI element and attribute information of the remaining GUI elements other than the changed GUI element connected thereto from the storage unit 130.

FIG. 4e illustrates an example of a theme setting display screen of another form in the first exemplary embodiment of the present invention.

If a pattern image theme setting menu is selected, the controller 160 extracts attribute information of the remaining GUI elements connected to all pattern images from the storage unit 130 and controls the display unit 150 to display a preview image of a theme formed with a first pattern image and attribute information of the remaining GUI elements connected thereto.

In a display screen of FIG. 4e, an upper part represents a preview image of a theme formed with attribute information of the remaining GUI elements connected to a first pattern image (wave pattern) and a lower part represents a menu for selecting a pattern image and a menu for selecting a background color. When a background color connected to a pattern image of a wave pattern corresponds to a sky blue color, the controller 160 controls the display unit 150 to display a color chip to position at a sky blue color in a menu for changing a background color. The user requests storage of a particular theme displayed on a preview screen preferably by activating a setting completion key. When the user tries to change a pattern image, the user can change a pattern image using a pattern image selection menu positioned at a lower part of a display screen. When the user changes the pattern image to a second pattern image, the controller 160 controls the display unit 150 to display a preview image of a theme formed with a second pattern image and attribute information of the remaining GUI elements connected thereto. The background color can be changed using a background screen color change menu and can sequentially change a main character color, title/low end area color, title/low end character color, selection area (focus area) color, and selection area character color using a ‘previous’ or ‘next’ menu. In the first exemplary embodiment of the present invention, the user can compose a theme by only setting attribute information of some GUI elements including a pattern image, and can more conveniently compose a theme by changing additionally GUI elements in the composed theme.

FIG. 5 is a flowchart illustrating a method of setting a theme according to a second exemplary embodiment of the present invention.

The controller 160 determines that a theme setting menu is selected by the user using the input unit 140 (505). When the controller 160 determines an input of a theme setting menu, the controller 160 controls the display unit 150 to display lower-level menus of the theme setting menu. In the second exemplary embodiment of the present invention, a case of selecting a preset theme setting menu of theme setting lower-level menus is described.

At step (510), the controller 160 determines that a preset theme setting menu is selected by the user using the input unit 140.

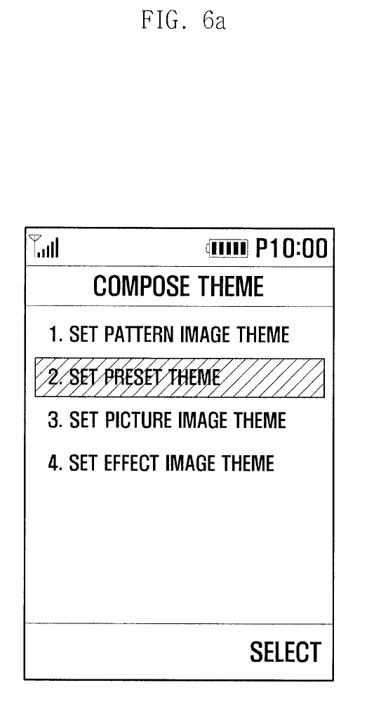

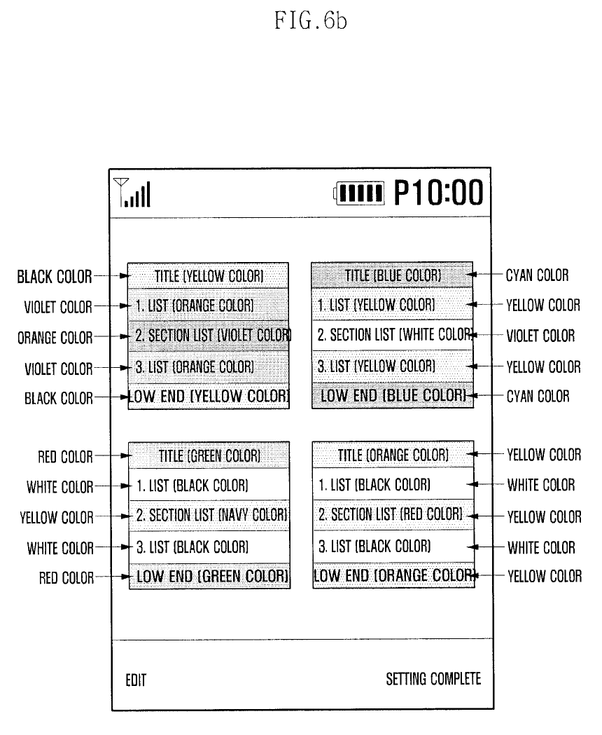

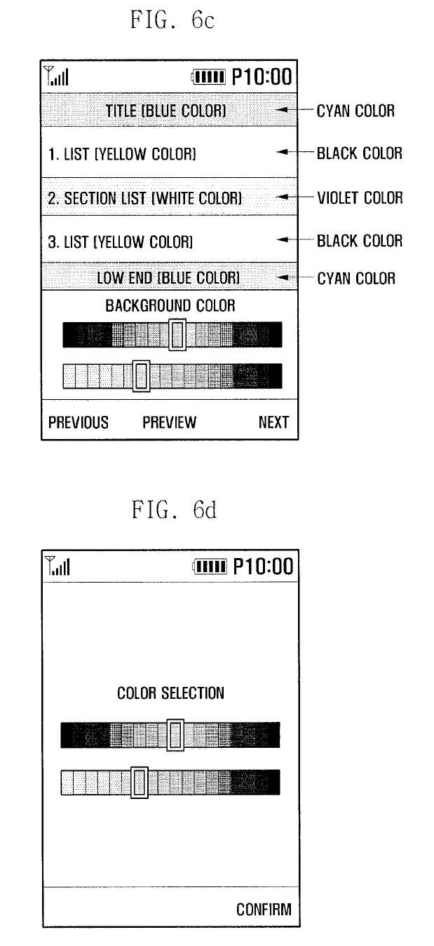

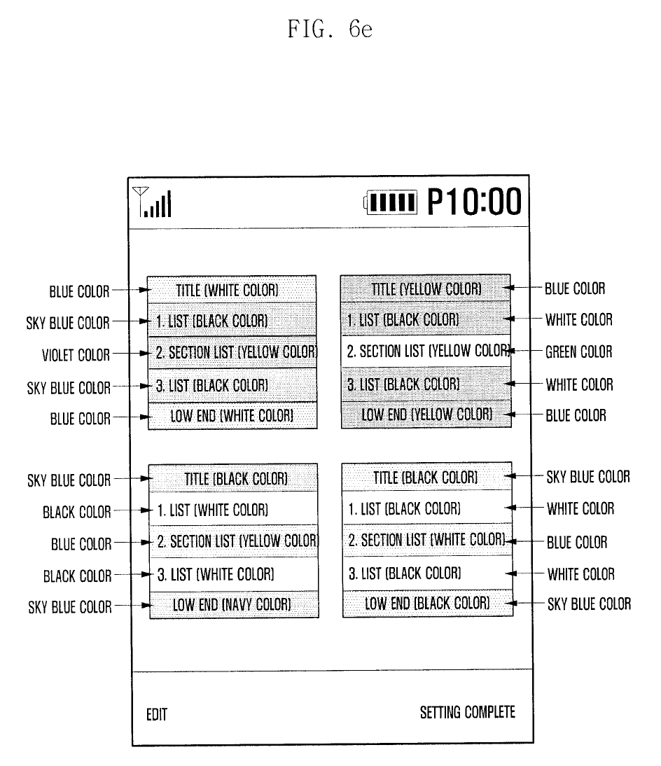

FIG. 6a illustrates a display screen for selecting a preset theme setting menu of theme setting lower-level menus.

At step (515), when a preset theme setting menu is selected, the controller 160 extracts a preset plurality of themes stored in the storage unit 130 and controls the display unit 150 to display the extracted themes.

FIG. 6b illustrates a display screen for displaying themes stored in the mobile terminal.

FIG. 6b illustrates themes formed in several forms, and one of themes displayed in the display unit 150 is selected by the user.

At step (520), the controller 160 determines whether one of a plurality of themes displayed in the display unit 150 has been selected.

FIG. 6b illustrates a display screen for selecting a second theme.

At step (525), if a theme is selected, the controller 160 determines whether a setting completion key is input by the user using the input unit 140. When the user tries to store the theme selected at step 520, the setting completion key is input.

At step (530), if a setting completion key is input, the controller 160 stores the selected theme in the storage unit 130.

If a setting completion key is not activated at step 525, then at step (535) the controller 160 determines whether an editing key is input by the user using the input unit 140. When the user wants to edit instead of storing the theme selected at step 520, an editing key is input.

If an editing key is activated, at step (540) the controller 160 controls the display unit 150 to display a menu for changing attribute information of a GUI element. For example, the controller 160 may control the display unit 150 to display step by step a menu for changing a background screen color, main character color, title/low end area color, title/low end character color, selection area (focus area) color, selection area character color, and the user can gradually change from the background screen color to the selection area character color. Each step menu can be formed with a menu for changing a hue, brightness, and opacity.

FIG. 6c illustrates a menu for changing attribute information of a GUI element according to an exemplary embodiment of the present invention. The user can change a background color using a color adjustment bar positioned at a lower part of the display screen.

With continued reference to FIG. 5, at step (545), the controller 160 determines that an instruction for changing attribute information of a GUI element is input by the user and controls the display unit 150 to change and display a theme to correspond to the changed attribute information. In the present exemplary embodiment, the controller 160 extracts attribute information of a GUI element changed by the user and attribute information of the remaining GUI elements connected thereto from the storage unit 130 and controls the display unit 150 to display the extracted attribute information. For example, when a main character color of an ‘orange color’, title/low end area color of a ‘black’ color, title/low end character color of a ‘yellow’ color, selection area (focus area) color of an ‘orange color’, and selection area character color of a ‘violet’ color are connected to a background screen color of a ‘violet’ color and they are stored, if the user changes a background screen color to a ‘violet’ color, the controller 160 extracts attribute information of the remaining GUI elements connected to a background screen color of the ‘violet’ color from the storage unit 130 and controls the display unit 150 to display the extracted attribute information.

In the present exemplary embodiment, when a preset theme setting menu is selected at step 510, the controller 160 controls the display unit 150 to display a color selection menu.

FIG. 6d illustrates a display screen for displaying a color selection menu according to an exemplary embodiment of the present invention.

The color selection menu is a menu for selecting entire color series of a theme. For example, when the user tries to entirely compose a theme with blue color series, a blue color is selected from a color selection menu. The color selection menu can be formed with a menu that can adjust a hue, brightness, and opacity, the menus can be formed with a plurality of steps, and the user can select a color using the menus. The storage unit 130 according to the second exemplary embodiment of the present invention can classify and store themes on a color series basis. The controller 160 determines a color selected by the user and extracts a theme formed with attribute information of GUI element connected to correspond thereto from the storage unit 130. The controller 160 controls the display unit 150 to display the extracted themes.

FIG. 6e illustrates a display screen for displaying themes according to a color selected by the user. FIG. 6e illustrates themes included in blue color series and the user can select one of the listed themes and store the selected theme in a theme list. When the user tries to change attribute information of some GUI elements, attribute information of GUI elements can be changed using a theme editing function.

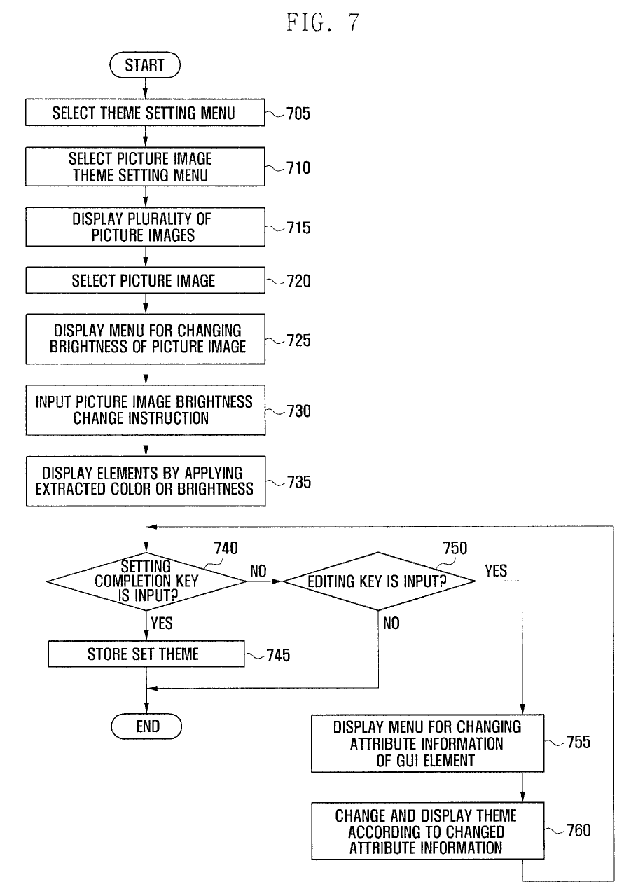

FIG. 7 is a flowchart illustrating a method of setting a theme according to a third exemplary embodiment of the present invention.

At step (705), the controller 160 determines that a theme setting menu is selected by the user using the input unit 140. When the controller 160 determines an input of a theme setting menu, the controller 160 controls the display unit 150 to display lower-level menus of the theme setting menu. In the third exemplary embodiment of the present invention, a case of selecting a picture image theme setting menu of theme setting lower-level menus is described.

At step (710), the controller 160 determines that a picture image theme setting menu is selected by the user using the input unit 140.

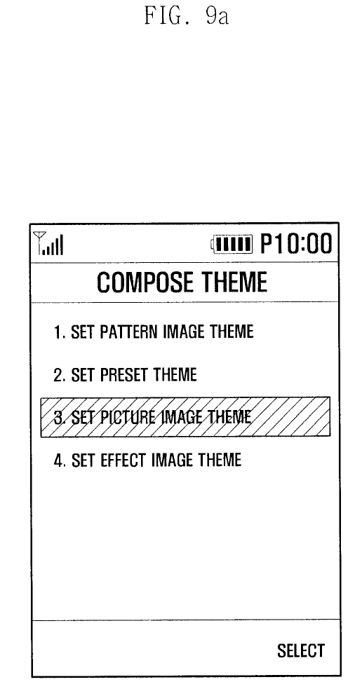

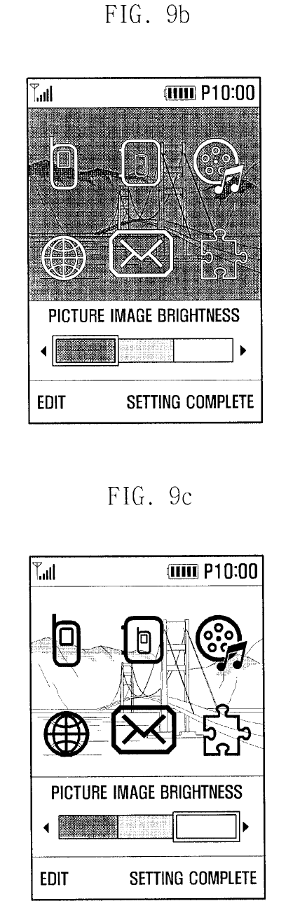

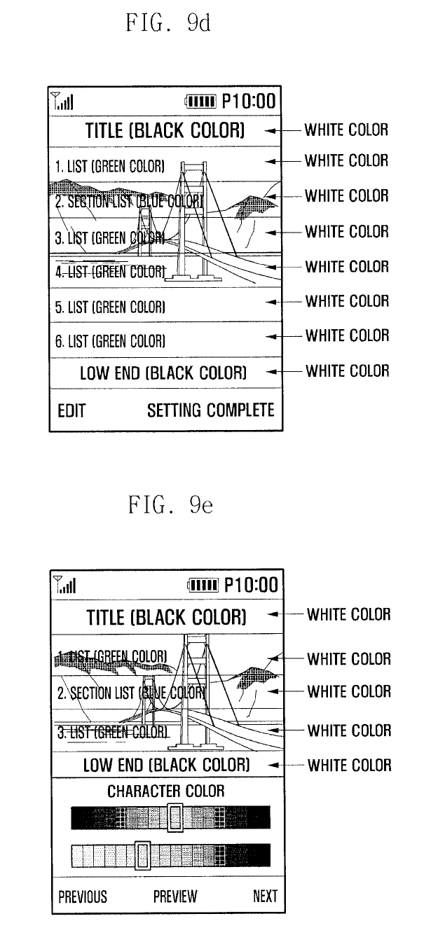

FIG. 9a illustrates a display screen for selecting a picture image theme setting menu of theme setting lower-level menu.

At step (715), when a picture image theme setting menu is selected, the controller 160 extracts a plurality of picture images stored in the storage unit 130 and controls the display unit 150 to display the extracted picture images. In the present exemplary embodiment, a picture image is an image photographed by the user through a camera module of the mobile terminal or a picture image received from the outside.

At step (720), the controller 160 determines that one of a plurality of picture images displayed in the display unit 150 is selected by the user using the input unit 140.

At step (725), the controller 160 controls the display unit 150 to display a menu for changing brightness of a picture image.

FIG. 9c illustrates a menu screen for changing brightness of a picture image.

In FIG. 9c, a menu for changing brightness of a picture image is formed in a control bar form, and a control bar is divided in this example into brightness of 3 steps. In the present exemplary embodiment, a picture image brightness change menu can be formed in other forms other than a control bar and may have a menu form that can be adjusted to brightness of at least 3 steps. In the present exemplary embodiment, the controller 160 controls the display unit 150 to display GUI elements stored to connect to a picture image on a menu screen for changing brightness of a picture image. A screen in which GUI elements are displayed on a picture image may be a preview image of a theme to be set.

FIG. 9b illustrates a plurality of icons overlapped on the selected picture image.

In the present exemplary embodiment, a color or brightness of a GUI element preferably corresponds to brightness of a picture image is set and stored in the storage unit 130.

With continued reference to FIG. 7, at step (730), the controller 160 determines that a picture brightness change instruction is input by the user using the input unit 140 and extracts a color or brightness of a GUI element corresponding to picture image brightness from the storage unit 130.

At step (735), the controller 160 controls the display unit 150 to display GUI elements by applying the extracted color or brightness.

FIG. 9c illustrates a display screen in which a color of an icon is changed, as brightness of a picture image is changed.

FIG. 9b illustrates an icon of a ‘white’ color corresponding to a picture image of “dark” brightness on the display screen, and FIG. 9c illustrates an icon of a ‘black’ color corresponding to a picture image of “bright” brightness on a display screen.

At step (740), the controller 160 determines whether a setting completion key is input by the user using the input unit 140. When the user tries to store the theme displayed at step 735, the setting completion key is activated. An artisan should understand and appreciate throughout this application, the inputting or activation of a key does not in fact have to be a physical key, and may comprise a key visually displayed on a touchpad, that may or may not be activated by a stylus, clicking a pointer, or by moving the portable terminal with certain exaggerated motion defined for activation of a particular function.

At step (745), if a setting completion key is input, the controller 160 stores the set theme in the storage unit 130.

At step (750), if a setting completion key is not input, the controller 160 determines whether an editing key is input by the user using the input unit 140.

When the user tries to edit a color or brightness of an icon instead of storing the theme displayed at step 735, an editing key is input.

At step (755), if an editing key is input, the controller 160 controls the display unit 150 to display a menu for changing attribute information of a GUI element.

A menu for changing attribute information of a GUI element according to the third exemplary embodiment of the present invention may comprise a menu for changing a color or brightness of GUI elements displayed on a picture image.

At step (760), the controller 160 determines that an instruction for changing attribute information of a GUI element is input by the user using the input unit 140 and controls the display unit 150 to change and display a theme according to the changed attribute information.

When the user tries to adjust a color of an icon displayed in FIG. 9c, a color of the icon can be adjusted from a ‘black’ color to a ‘gray color’ by inputting an editing key.

In the third exemplary embodiment of the present invention, a reference point of a color or brightness of GUI elements such as an icon is provided according to brightness of a picture image selected to a background image, a color or brightness of GUI elements can be changed based on the reference point, and thus a method of easily composing a theme can be provided to the user.

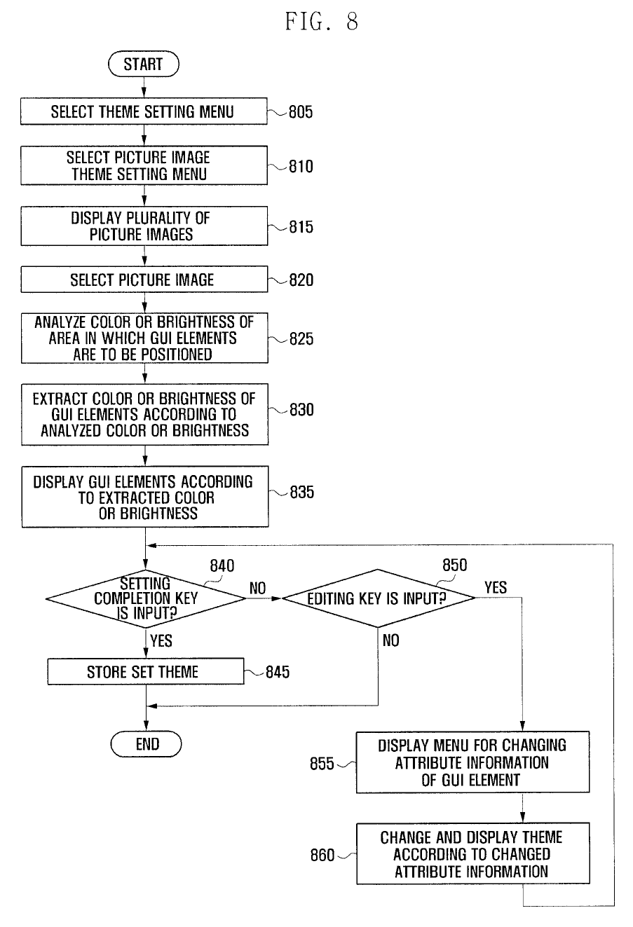

FIG. 8 is a flowchart illustrating a method of setting a theme according to a fourth exemplary embodiment of the present invention.

A process from step 805 to step 820 is similar to step 705 to step 720 in the third exemplary embodiment of the present invention.

At step (820), when any one picture image is selected, the controller 160 analyzes a color or brightness of an area at which GUI elements are to be positioned in the selected picture image. A theme is displayed in a form in which GUI elements are overlapped on a picture image, and the controller 160 analyzes a color or brightness of a picture image portion overlapped with an area at which each of the GUI elements is positioned.

At step (830) The controller 160 extracts data about a color or brightness of GUI elements stored to correspond to the analyzed color or brightness from the storage unit 130.

In the fourth exemplary embodiment of the present invention, GUI elements to be displayed together with a picture image preferably include a main character, title/low end area, title/low end character, selection area (focus), and selection area character. For example, when a color of a picture image portion overlapped with an area at which a title/low end area is positioned is analyzed as a ‘yellow’ color and a color of a title/low end area corresponding to a yellow color is stored to connect to a ‘white’ color, the controller 160 extracts a ‘white’ color as a color of a title/low end area. In the present exemplary embodiment, when the controller 160 extracts a color or brightness of a picture image, the controller 160 extracts a specific point in a corresponding area on the picture image as a sample and analyzes a color or brightness.

At step (835), the controller 160 controls the display unit 150 to display GUI elements according to the extracted color or brightness (835).

FIG. 9e illustrates a theme formed with GUI elements in which the extracted color or brightness is reflected.

Each of GUI elements is displayed with a color and brightness connected to correspond to a color or brightness of a picture image.

At step (840), the controller 160 determines whether a setting completion key is input by the user using the input unit 140. When the user tries to store a theme displayed at step 835, the setting completion key is input.

At step (845), if a setting completion key is input, the controller 160 stores the set theme in the storage unit 130.

At step (850), if a setting completion key is not input at step 840, the controller 160 determines whether an editing key is input by the user using the input unit 140.

When the user tries to change a color or brightness of GUI elements instead of storing the theme displayed at step 835, an editing key is activated.

If an editing key is activated, at step (855), the controller 160 controls the display unit 150 to display a menu for changing attribute information of a GUI element.

FIG. 9e illustrates a menu screen for changing attribute information of GUI elements.

The invention permits change of, for example, a main character color, title/low end area color, title/low end character color, selection area (focus area) color, and selection area character color through the menu screen.

At step (860), the controller 160 determines that an instruction for changing attribute information of a GUI element is received and controls the display unit 150 to change and display a theme according to the changed attribute information.

In the present exemplary embodiment, an attribute information combination of some of GUI elements composing a theme and attribute information of the remaining GUI elements can be connected and stored. In this case, the controller 160 extracts attribute information of the remaining GUI elements stored to connect to attribute information of a GUI element changed by the user from the storage unit 130 and controls the display unit 150 to display the extracted attribute information. For example, when main character color and a title/low end area color are changed, the controller 160 extracts a title/low end character color, selection area (focus area) color, and selection area character color stored to connect to the changed main character color and title/low end character color combination from the storage unit 130 and controls the display unit 150 to display the extracted title/low end character color, selection area (focus area) color, and selection area character color.

In the fourth exemplary embodiments of the present invention, by analyzing a color and brightness of an area at which GUI elements are to be positioned in a picture image and by selecting a color and brightness of GUI elements corresponding thereto, a reference theme is presented and by enabling the user to additionally change a theme based on the reference theme, user convenience can be provided upon setting the theme.

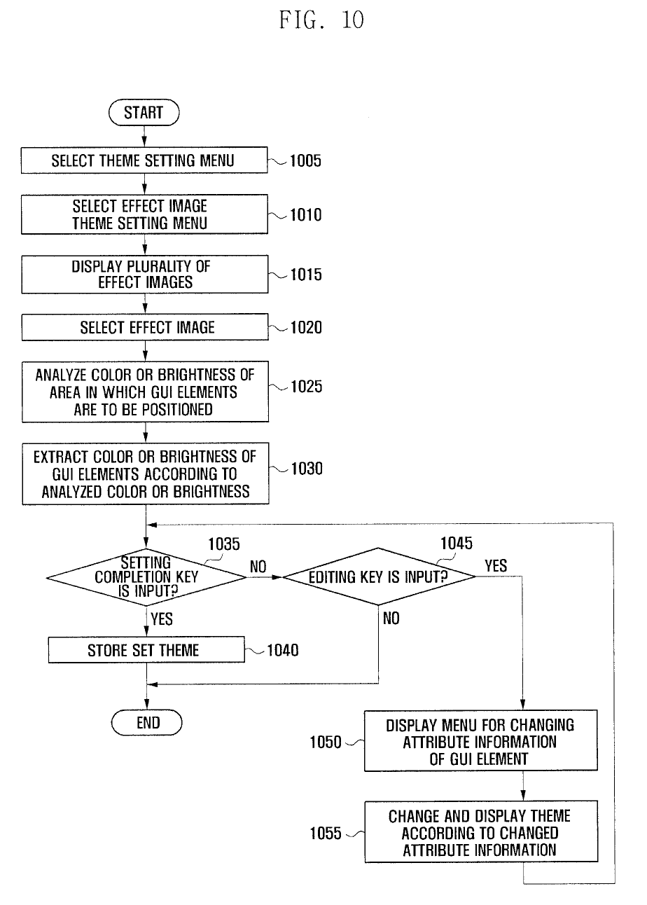

FIG. 10 is a flowchart illustrating a method of setting a theme according to a fifth exemplary embodiment of the present invention.

At step (1005), the controller 160 determines that a theme setting menu is selected by the user using the input unit 140. When the controller 160 determines an input of a theme setting menu, the controller 160 controls the display unit 150 to display lower-level menus of a theme setting menu. In a fifth exemplary embodiment of the present invention, a case of selecting an effect image theme setting menu of a theme setting lower-level menu is now described.

At step (1010), the controller 160 determines that an effect image theme setting menu is selected by the user using the input unit 140. In the present invention, an effect image corresponds to an image for displaying a selection area (focus area) of a user on a menu screen.

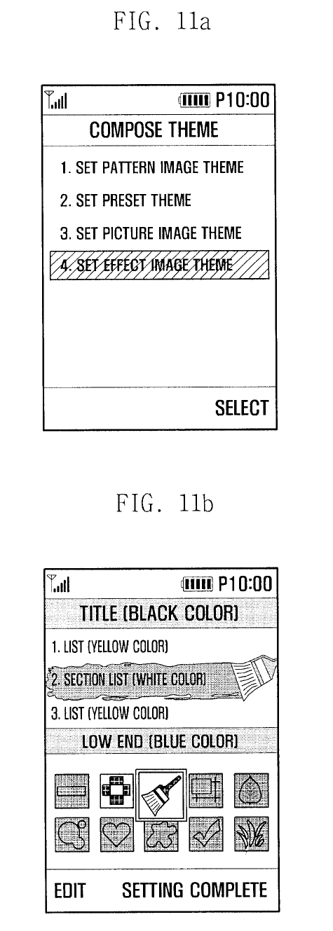

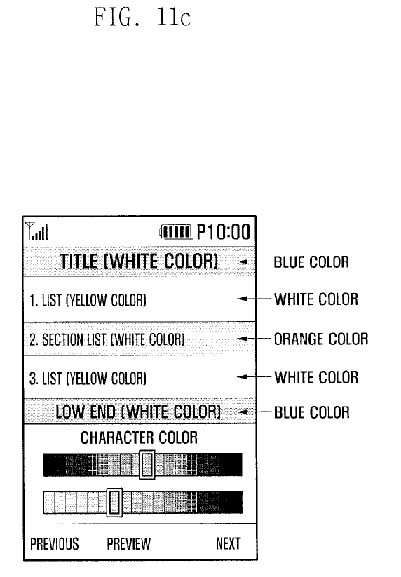

FIG. 11a illustrates a display screen for selecting an effect image theme setting menu of theme setting lower-level menus.

When an effect image theme setting menu is selected, at step (1015) the controller 160 extracts a plurality of effect images stored in the storage unit 130 and controls the display unit 150 to display the extracted effect images.

An image of an icon form displayed in a lower part of FIG. 11b corresponds to an effect image according to an exemplary embodiment of the present invention.

At step (1020), the controller 160 determines that one of a plurality of effect images displayed in the display unit 150 is selected by the user using the input unit 140 and received by the controller.

At step (1025), the controller 160 extracts attribute information of the remaining GUI elements stored to connect to the selected effect image from the storage unit 130. A theme according to the fifth exemplary embodiment of the present invention can be formed with GUI elements of a background image, main character, title/low end area, title/low end character, selection area (focus area), and selection area character. Even in the fifth exemplary embodiment, an attribute information combination of a plurality of GUI elements and attribute information of the remaining GUI elements can be connected and stored, as in the first exemplary embodiment, and in this case, the controller 160 determines that attribute information of a plurality of GUI elements is selected by the user and extracts attribute information of the remaining GUI elements connected to attribute information of the selected GUI elements from the storage unit 130 and controls the display unit 150 to display the extracted attribute information.

At step (1030), the controller 160 forms a theme based on the extracted attribute information and controls the display unit 150 to display a theme.

FIG. 11b illustrates a menu for selecting an effect image and a preview screen of a theme formed by the controller 160.

When the user selects one of a plurality of effect images, the selected image is displayed as a preview screen reflecting attribute information of the remaining GUI elements stored to correspond thereto. For example, when the user selects a paint effect image as an effect image, the controller 160 controls the display unit 150 to display a background image color, main character color, title/low end area color, title/low end character color, selection area (focus area) color, selection area character color stored to correspond to the paint effect image.

With continued reference to FIG. 10, at step (1035), the controller 160 determines whether a setting completion key is input by the user using the input unit 140. When the user tries to store a theme displayed at step 1030, the setting completion key is input.

At step (1040), if a setting completion key is input, the controller 160 stores the composed theme in the storage unit 130.

At step (1045), if a setting completion key is not input at step 1035, the controller 160 determines whether an editing key is input by the user using the input unit 140.

When the user wants to adjust a theme instead of storing the theme displayed at step 1030, an editing key is input.

At step (1050), if an editing key is input, the controller 160 controls the display unit 150 to display a menu for changing attribute information of a GUI element.

FIG. 11c illustrates a menu for changing attribute information of a GUI element according to an exemplary embodiment of the present invention.

The user can change a character color using a color adjustment bar positioned at a lower part of the display screen.

At step (1055), the controller 160 determines that an instruction for changing attribute information of a GUI element is input by the user using the input unit 140 and controls the display unit 150 to change and display a theme according to the changed attribute information.

In the fifth exemplary embodiments of the present invention, when attribute information of a GUI element is changed by the user, as in the first exemplary embodiment, the controller 160 extracts attribute information of the remaining GUI elements connected to correspond to attribute information of the changed GUI element from the storage unit 130 and controls the display unit 150 to display the extracted attribute information.

In the fifth exemplary embodiment of the present invention, the user receives a reference theme most appropriate for the selected effect image and composes a theme based on the received reference theme, and thus user convenience is provided upon composing a theme.

According to exemplary embodiments of the present invention, GUI elements composing a theme can be formed with a plurality of layers. For example, in the fifth exemplary embodiment, a paint image displayed in a focus area according to a paint effect image can be formed with a combination of a plurality of images. GUI elements formed with a plurality of layers can provide a three-dimensional image effect to the user, and because a plurality of layers is connected to each other, the user can compose more easily a theme.

As described above, according to the present invention, a user can more easily and conveniently compose a GUI related to a theme.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

The above-described methods according to the present invention can be realized in hardware or as software or computer code that can be stored in a recording medium such as a CD ROM, a RAM, a floppy disk, a hard disk, thumbnail drive, memory stick, memory card, etc., or a magneto-optical disk or downloaded over a network, so that the methods described herein can be executed by such software using a general purpose computer, or a special processor or microprocessor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. A method of composing a guide user interface (GUI) of a mobile terminal, comprising:
(a) identifying attribute information of at least one GUI element of a plurality of GUI elements composing a display screen of the mobile terminal;
(b) extracting attribute information of the remaining GUI elements other than said at least one GUI element identified in (a) from among the plurality of GUI elements composing a display screen based on the attribute information of said at least one GUI element identified in (a);
(c) displaying the plurality of GUI elements reflecting the identified attribute information and the extracted attribute information; and
(d) composing, upon a setting completion key being activated, a GUI with the displayed plurality of GUI elements.

2. The method of claim 1, wherein extracting attribute information of the remaining GUI elements in (b) comprises:
extracting attribute information of the remaining GUI elements connected to the attribute information of the identified GUI element, when attribute information of one GUI element is identified u in (a), and
extractingattribute information of the remaining GUI elements connected to an attribute information combination of the identified GUI elements, when attribute information of the plurality of GUI elements is identified in (a).

3. The method of claim 1, further comprising:
after displaying the plurality of GUI elements reflecting the indentified attribute information and the extracted attribute information,
displaying a menu screen for changing attribute information of the displayed GUI elements, if an editing instruction of the GUI element is received, and
displaying GUI elements reflecting the changed attribute information, if an instruction for changing attribute information of at least one GUI element of the displayed GUI elements is input.

4. The method of claim 3, wherein displaying GUI elements reflecting the changed attribute information comprises:
extracting attribute information of the GUI element in which the attribute information of the displayed GUI elements is identified and GUI elements other than a particular GUI element in which the attribute information is changed based on the changed attribute information of the GUI element and attribute information of the identified GUI element when identifying attribute information of at least one GUI element of a plurality of GUI elements composing a display screen of the mobile terminal; and
displaying GUI elements comprising the identified attribute information, the changed attribute information, and the extracted attribute information.

5. The method of claim 1, wherein the GUI element comprises a predetermined divided area and icon for displaying a background image, a character, and a display screen.

6. The method of claim 5, wherein the predetermined divided area comprises a first portion for displaying a menu title, a second portion at which a menu selected by a user is positioned, a third portion at which a menu that is not selected by the user is positioned, a fourth portion in which a soft key character is displayed, and a fifth portion in which a pop-up window is displayed on a menu screen.

7. The method of claim 1, wherein attribute information of the GUI element comprises one or more of a kind, a shape, a color, a brightness, a display effect of a background image, a character, a predetermined area, and an icon.

8. The method of claim 5, wherein when a generated picture image is identified as attribute information of the background image, extracting attribute information of the remaining GUI elements other than said at least one GUI element in which the attribute information is identified among the plurality of GUI elements in (a) comprises extracting a color or brightness of the remaining GUI elements connected to brightness of the selected picture image.

9. The method of claim 8, further comprising displaying a menu for changing brightness of the picture image.

10. The method of claim 9, further comprising extracting a color or brightness of the remaining GUI elements connected to brightness of the changed picture image.

11. A mobile terminal for composing a GUI, comprising:
a storage unit for connecting and storing attribute information of the remaining GUI elements to attribute information of at least one GUI element of a plurality of GUI elements composing a display screen;
a display unit for displaying a menu screen for composing a particular GUI and for displaying the composed particular GUI; and
a controller for controlling composition of a GUI by extracting attribute information of the remaining GUI elements connected to identified attribute information from the storage unit and to display the composed GUI in the display unit, if an instruction for identifying attribute information of at least one GUI element of a plurality of GUI elements composing the display screen is input by a user.

12. The mobile terminal of claim 11, wherein the controller controls display by the display unit of a menu for changing attribute information of a GUI element, if a GUI editing instruction is received by the controller.

13. The mobile terminal of claim 12, wherein the controller controls extracting attribute information of the remaining GUI elements connected to the identified attribute information and the changed attribute information, to compose a GUI, and the display unit to display the GUI, if an instruction for changing attribute information of at least one GUI element is received by the controller.

14. The mobile terminal of claim 12, wherein the controller controls display by the display unit of step-by-step menus for changing a background screen color, main character color, title/low end area color, title/low end character color, selection area (focus) color, and selection area character color, and the user can gradually change from the background screen color to the selection area character color.

15. The mobile terminal of claim 11, wherein if one of the displayed plurality of pattern images is identified for creating a GUI, the controller extracts attribute information of the remaining GUI elements connected to the identified pattern image from the storage unit.

16. The mobile terminal of claim 12, wherein the controller extracts attribute information of the remaining GUI elements stored to connect to attribute information of a GUI element from the storage unit that has been changed, and controls the display of the extracted attribute information associated with the changed GUI element.

17. The mobile terminal of claim 16, wherein a main character color and a title/low end area color are changed, the controller extracts a title/low end character color, selection area (focus area) color, and selection area character color stored to connect to the changed main character color and title/low end character color combination from the storage unit, and controls display of the extracted title/low end character color, selection area (focus area) color, and selection area character color.

18. The mobile terminal of claim 11, wherein one or more of a plurality of themes are stored in the storage unit are transmitted by an RF unit to another party through wireless communication or short range communication protocols.

19. The mobile terminal of claim 18, wherein the wireless communication and short range communication protocols include Bluetooth, Zigbee, and IrDA.
